(19) United States
(12) Patent Application Publication
(10) Pub. No.: US 2007/0156471 A1
(43) Pub. Date: Jul. 5, 2007

(54) Spectral method for sparse principal component analysis

(76) Inventors: Baback Moghaddam, Cambridge, MA (US); Yair Weiss, Jerusalem (IL); Shmuel Avidan, Brookline, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/289,343

(22) Filed: Nov. 29, 2005

(51) Int. Cl. G06F 9/44; G06F 17/50; G06Q 40/00

(52) U.S. Cl. 705/7; 705/35

(57) ABSTRACT

A method maximizes a candidate solution to a cardinality-constrained combinatorial optimization problem of sparse principal component analysis. An approximate method has as input a covariance matrix A, a candidate solution, and a sparsity parameter k. A variational renormalization for the candidate solution vector x with regards to the eigenvalue structure of the covariance matrix A and the sparsity parameter k is then performed by means of a sub-matrix eigenvalue decomposition of A to obtain a variance maximized k-sparse eigenvector x that is the best possible solution. Another method solves the problem by means of a nested greedy search technique that includes a forward and backward pass. An exact solution to the problem initializes a branch-and-bound search with an output of a greedy solution.

### FIELD OF THE INVENTION

This invention relates generally to principal component analysis (PCA), and more particularly to applying sparse principle component analysis to practical applications such as face recognition and financial asset management.

### BACKGROUND OF THE INVENTION

Principal component analysis (PCA) is a well-known multivariate statistical analysis technique. PCA is frequently used for data analysis and dimensionality reduction. PCA has applications throughout science, engineering, and finance.

PCA determines a linear combination of input variables that capture a maximum variance in data. Typically, PCA is performed using singular value decomposition (SVD) of a data matrix. Alternatively, if a covariance matrix is used, then eigenvalue decomposition can be applied. PCA provides data compression with a minimal loss of information. In addition, the principal components are uncorrelated. This facilitates data analysis.

Unfortunately, PCA usually involves non-zero linear combinations or ‘loadings’ of all of the data. However, for many practical applications, such as bioinformatics, computational biology, computer vision, financial asset management, and analysis of geophysical, genetic and medical data, the coordinate axes have a physical meaning. Therefore, it would be an advantage to reduce the number of non-zero loadings. This would provide ‘sparse’ principal components having a low-dimensionality that still characterize the variance in the data.

Sparse data representations are generally desirable because sparse representations aid in human understanding, reduce computational costs, and provide better generalization in learning models.

For applications such as financial portfolio optimization and resource allocation in geo-spatial statistics, sparseness is often the key defining criterion whether space/time and material costs can constrain the number of investment or measurement units. In machine learning, sparseness in the input data is related to feature selection and automatic relevance determination.

Conventional sparse PCA typically applies simple transforms such as axis rotations and component thresholding, J. Cadima and I. Jolliffe, “Loadings and correlations in the interpretation of principal components,” Applied Statistics, vol. 22, pp. 203-214, 1995. Essentially, the underlying goal is a selection of a subset of the features for regression analysis, often based on the identification and analysis of principal variables, G. McCabe, “Principal variables,” Technometrics, vol. 26, pp. 137-144, 1984.

The first true computational method, SCoTLASS, provides a proper optimization framework. However, that method is computationally impractical, I. Jolliffe and M. Uddin, “A modified principal component technique based on the Lasso,” Journal of Computational and Graphical Statistics, vol. 12, pp. 531-547, 2003.

Another method uses an ElasticNet formulation with an L₁-penalized regression on conventional principal components, H. Zou, T. Hastie, and R. Tibshirani, “Sparse principal component analysis,” Journal of Computational and Graphical Statistics, to appear.

Another method recognizes the problems associated with sparse PCA, i.e., its highly non-convex objective function, A. d'Aspremont, L. El Ghaoui, M. I. Jordan, and G. R. G. Lanckriet, “A direct formulation for sparse PCA using semi-definite programming,” Advances in Neural Information Processing Systems (NIPS), December 2004. That method relaxes the hard cardinality constraint by solving for a convex approximation using semi-definite programming (SDP).

### SUMMARY OF THE INVENTION

Sparse principal component analysis (PCA) of data determines a basis of sparse eigenvectors. A projection of the sparse eigenvectors represents a maximal variance of the data. Sparse PCA belongs to a specific class of NP-hard, cardinality-constrained, non-convex optimization problems. Sparse PCA can be used for a wide range of applications, from bio-informatics to computational finance and computer vision.

Conventional sparse PCA typically uses continuous approximations and convex relaxations to determine sparse principal components.

The invention provides a novel sparse PCA method. The method uses a discrete formulation based on variational eigenvalue bounds. The method determines optimal sparse principal components. The method can use approximate greedy and exact branch-and-bound search processes.

In addition, a simple post-processing renormalization step using a discrete spectral formulation can be applied to improve approximate candidate solutions obtained by any PCA methods.

In one embodiment of the invention, a computer implemented method maximizes candidate solutions to a cardinality-constrained combinatorial optimization problem of sparse principal component analysis.

A candidate solution vector x of elements is provided along with a covariance matrix A that measures covariances between each possible pair of elements of the candidate solution vector x. The candidate solution can be found using a greedy search. A sparsity parameter k denoting a cardinality of final solution is also provided or determined automatically.

A variational renormalization for the candidate solution vector x with regards to the covariance matrix A and the sparsity parameter k is then performed to obtain a variance maximized k-sparse eigenvector x that is locally optimal for the sparsity parameter k and that is the final solution to the sparse principal component analysis optimization problem.

### BRIEF DESCRIPTION OF THE DRAWINGS

FIG. 1 is a block diagram of a maximized solution to a combinatorial optimization problem according to an embodiment of the invention;

FIG. 2 is a block diagram of a variational normalization procedure according to an embodiment of the invention;

FIG. 3 is a block diagram of a greedy solution to a combinatorial optimization problem according to an embodiment of the invention;

FIG. 4 is a block diagram of a forward search for the greedy solution according to an embodiment of the invention;

FIG. 5 is a block diagram of a backward search for the greedy solution according to an embodiment of the invention;

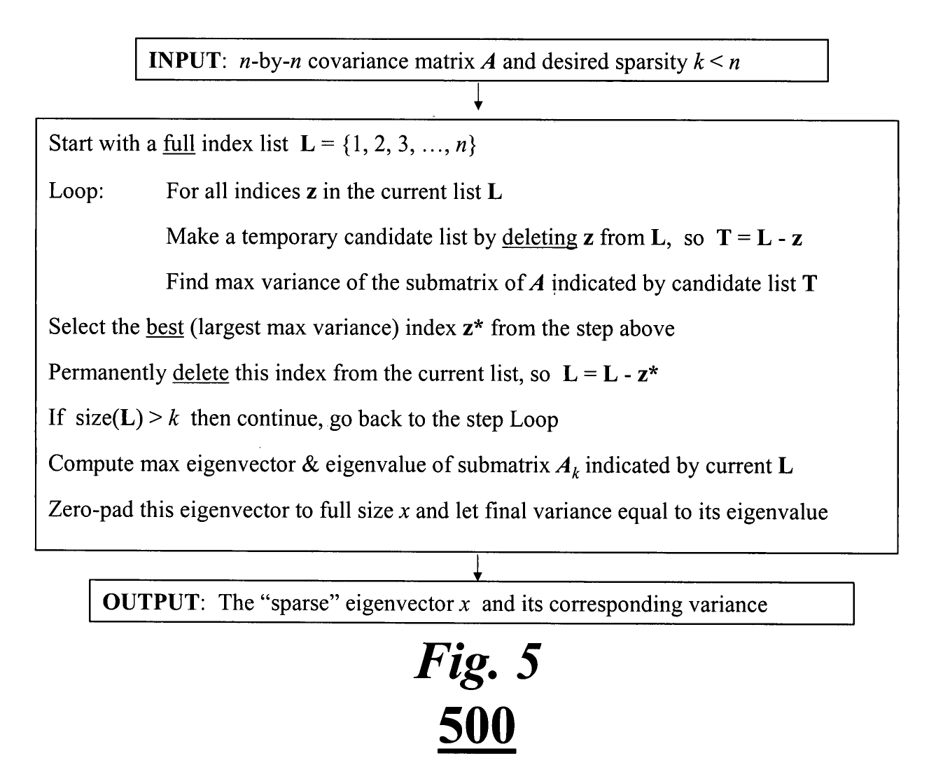

FIG. 6 is a block diagram of an exact solution to a combinatorial optimization problem according to an embodiment of the invention; and

FIG. 7 is a graph comparing variances according to embodiments of the invention.

### DETAILED DESCRIPTION OF THE PREFERRED EMBODIMENT

One embodiment of our invention provides a method for performing sparse principle component analysis on data using spectral bounds. The sparse PCA can be used to find solutions to practical combinatorial optimization problems.

In contrast with the prior art, our invention uses a discrete formulation based on variational eigenvalue bounds. The method determines optimal sparse principal components using a greedy search for an approximate solution and a branch-and-bound search for an exact solution.

For example, the method can be used to optimally solve the following practical stock portfolio optimization problem. It is desired to invest in ten stocks x picked from a substantially larger pool of available stocks, such as the 500 stocks listed by the Standard & Poor's Index. An input 500×500 covariance matrix A measures covariance in risk/return performances between each pair of the 500 stocks. It is desired to find a 500-dimensional vector x of allocations, such that x^{T}Ax/x^{T}x is maximized, subject to the constraint that there are only 10 non-zero elements in the final solution vector x.

This essentially can be broken down into two problems: picking the best ten stocks, and then allocating money across the selected stocks. The second problem is easier to solve than the first problem. The solution or “fix” to the second problem is as follows. Assume that the ten stocks have already been picked. Then, according to Proposition 1 described below, the best money allocation scheme extracts the rows/columns of the covariance matrix A that correspond to these ten stocks, and determines the leading or principal eigenvector, that is, the eigenvector corresponding to a maximum eigenvalue or variance. This is guaranteed to be the best local solution for the candidate solution, where by local we mean among all possible allocations using the same ten stocks.

Although this might appear as a simple solution, the prior art has never addressed this problem in this particular novel way. In other words, people have addressed the above two problems together, and therefore they came up with a list of 10 stocks AND the money allocated to each stock. They did not realize that after they have a list of 10 stocks, they should use the leading eigenvector to get the optimal solution to allocating money across the selected stocks.

The first problem is much harder to solve. In fact, this problem is what is known as NP-hard. By this we mean that the complexity of this problem is intrinsically harder than those problems that can be solved by a nondeterministic Turing machine in polynomial time. When a decision version of a combinatorial optimization problem belongs to the class of NP-complete problems, then the optimization version is NP-hard.

Therefore, we characterize the solution as follows. Given a candidate list of stocks, we know that its maximum is bounded by the eigenvalue of the corresponding submatrix of A. If we pick stocks A, B and C, then we generate a 3×3 matrix from A and determine its maximum eigenvalue. This will be the maximum value. Furthermore, if a list of 10 stocks is upper bounded by the leading eigenvalue of the corresponding 10×10 submatrix of A, then any subset of these 10 stocks is upper bounded as well by the leading eigenvalue of the 10×10 submatrix.

We use a combination of these two observations in a branch-and-bound search, which is guaranteed to find the globally optimal exact solution. A locally sub-optimal greedy search adds (or deletes) stocks one by one until the search terminates.

In a computer vision application, the same techniques can be used to determine a subset of pixels to process in an image. For example, in face recognition applications computational and memory resources are limited. Therefore, it makes sense to only operate on those pixels in an image that correspond to salient parts of the face.

Maximized Solution

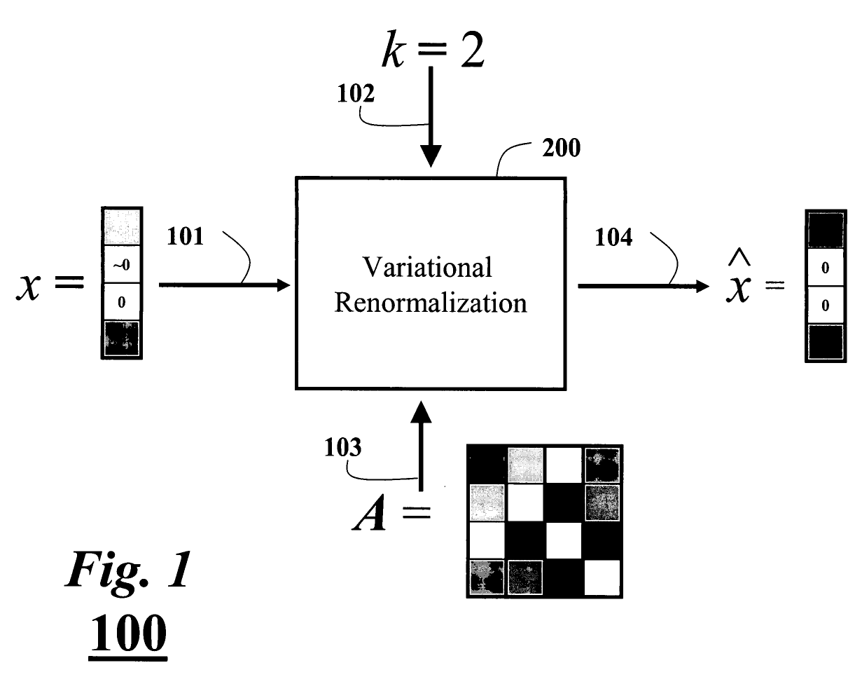

Using FIG. 1, we now describe a method 100 for improving a previously obtained candidate solution 101 to a practical combinatorial optimization problem. Inputs to the method are a data vector x 101 of elements that is the candidate solution of the problem, a covariance matrix A 103, and a sparsity parameter k 102. The sparsity parameter k denotes a maximum number of non-zero elements or “cardinality” in a final solution vector \hat{x} 104 of the problem.

For example, the elements in the data vector x corresponds to sparse investments in four available stocks or asset groups. The covariance matrix A measures the risk/return covariance of each available pair of elements among these four assets. The stocks and measures can be determined using any known methods. The sparsity parameter k is here set to two. In other words, the money is to be spread over only two of the four assets to obtain the best financial return.

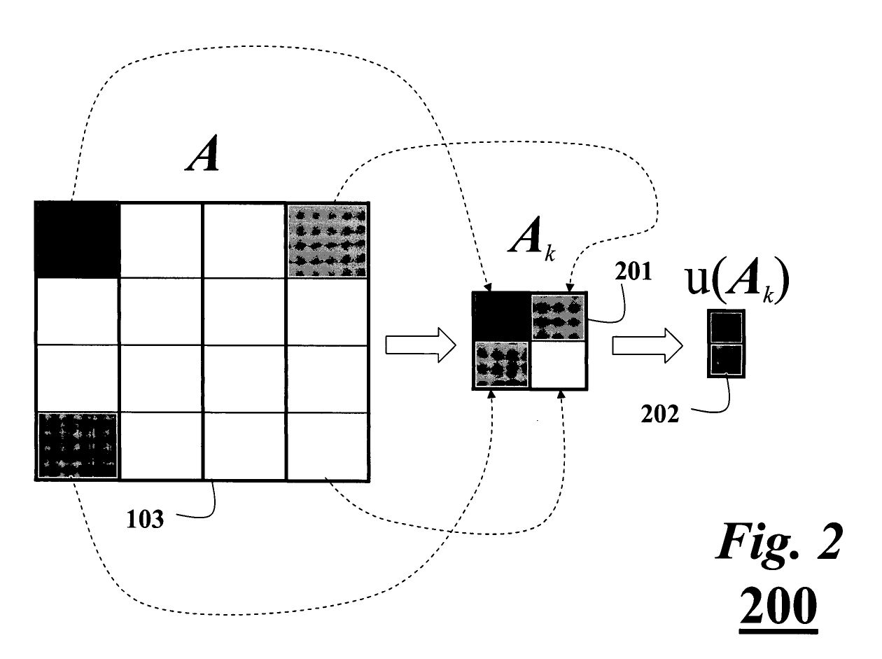

Variational renormalization 200 is performed according to the inputs to determine a maximized solution vector \hat{x} 104. As shown in FIG. 2, the variational renormalization 200 replaces the largest k elements 102 or “loadings” of the input data vector x 101 with the k elements of the principal eigenvector u(Aₖ) 202 of a corresponding k×k principal submatrix Aₖ 201 extracted from the rows and columns of the input matrix A 103, and setting all other elements of the vector x to zero to obtain the maximized final solution vector \hat{x} 104 to the practical combinatorial optimization problem.

Greedy Search Solution

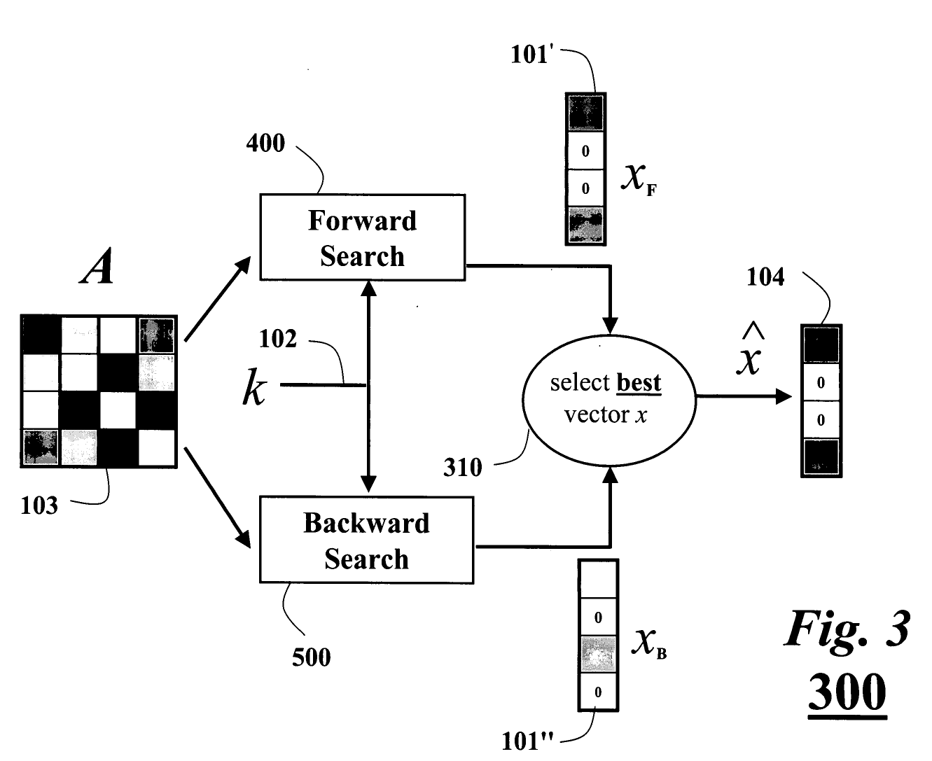

FIG. 3 shows the steps 300 of a greedy solution to the sparse PCA optimization problem. Inputs to the method are the covariance matrix A 103 and the sparsity parameter k 102. Nested forward search 400 and backward search 500 are applied to obtain the candidate solution(s) 101′-101″. From these two candidate solutions, the one with the greater variance (maximal eigenvalue) is then selected 310 as the output sparse eigenvector (final solution vector) \hat{x} 104.

Forward & Backward Search

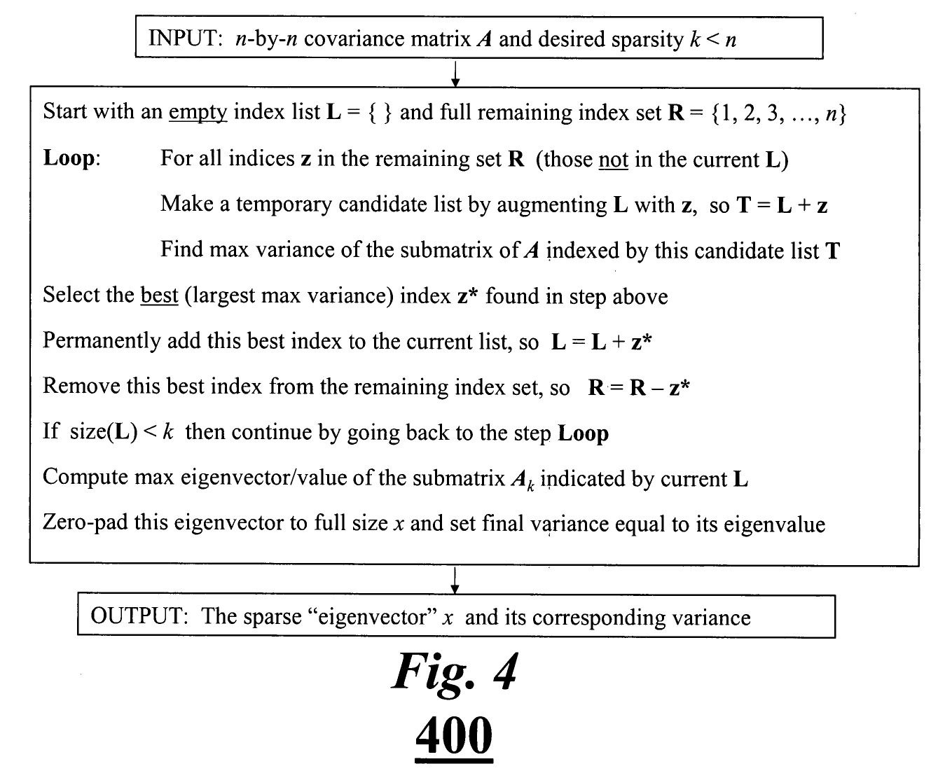

FIG. 4 shows the steps of the forward search 400. In this search, the list of candidate solutions is initially empty, and elements with the ‘best’ or largest maximum variance are added one by one up to value k. The corresponding backward search 500 starts with a full candidate list and elements are deleted one by one.

Exact Optimal Solution

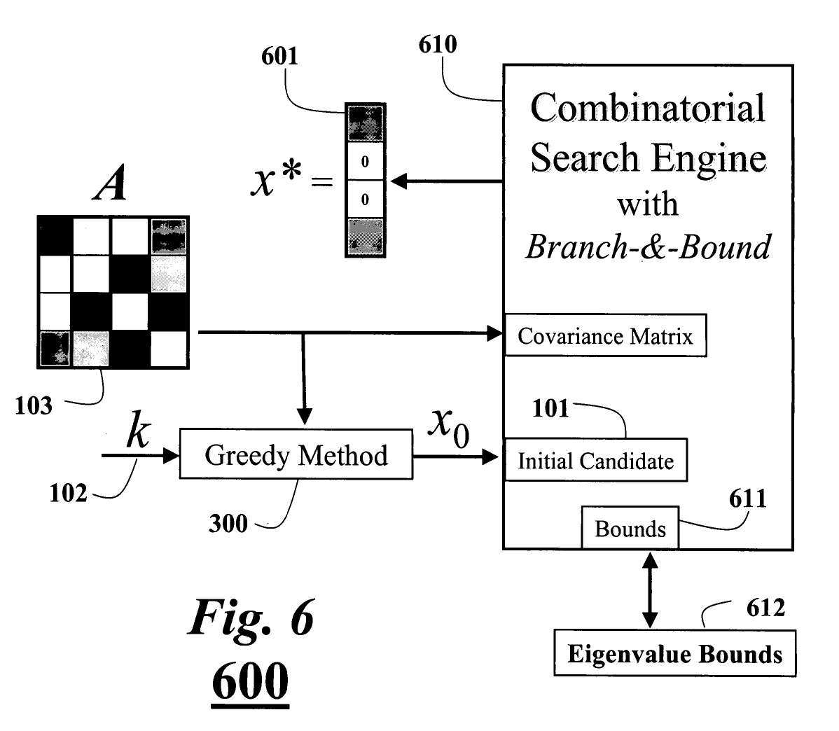

FIG. 6 shows the mechanism 600 for exact solutions to the sparse PCA problem. First, the bidirectional greedy method 300 is provided with the covariance matrix 103 and the desired sparsity parameter k 102 as before. The approximate solution of greedy search 300 provides an initial candidate solution x₀ 101 with its variance as an initial upper bound for subsequent use with a branch-and-bound combinatorial search 610 algorithm, using the covariance matrix 103, and the eigenvalue bounds 611 as described in greater detail below with respect to Equation (4). The branch-and-bound algorithm 610 is then guaranteed to find the exact optimal solution x* 601 when it terminates.

The embodiments of the invention are now described formally in greater detail.

Sparse PCA Formulation

In general, sparse principal component analysis (PCA) can be formulated as a cardinality-constrained quadratic program (QP). Given the symmetric, positive-definite covariance matrix A ∈ S₊ⁿ 103, we maximize a quadratic form x′Ax of the variance of a sparse measurement vector x ∈ [symbol] ⁿ 101 having no more than k<n non-zero principal components:
max x′ A x
subject to x′x=1
card(x)≦k, (1)
where a cardinality card(x)=|x|₀ is in a L₀-norm. This optimization problem is non-convex, NP-hard, and therefore intractable.

We solve for the optimal vector \hat{x} 104, and subsequent sparse eigenvectors are obtained using recursive decomposition of the covariance matrix A using conventional numerical routines.

In the decomposition, the sparseness of the eigenvectors is controlled by the values of the sparsity parameter k 102. For different values of k, the principal components are different. However, there are no guidelines for setting the value k, especially with multiple principal components and their interactions, e.g., a non-orthogonal basis, is likely.

Thus, unlike a conventional PCA, a sparse decomposition does not provide a unique solution. In fact, many different solutions are possible. Therefore, one embodiment of the invention ‘guides’ the selection of the sparsity parameter k. Consequently, the invention enables the determination of optimal sparse eigenvectors.

Without the cardinality constraint, the QP optimization in Equation (1) is a Rayleigh-Ritz quotient with analytic bounds
λₘᵢₙ(A)≦x′Ax/x′x≦λₘₐₓ(A)
and with corresponding unique eigenvector solutions.

As such, the optimal objective value or variance is just the maximum eigenvalue λₙ(A) using the principal eigenvector \hat{x}=uₙ. The rank of all (λᵢ, uᵢ) is in an increasing order of magnitude. Hence, λₘᵢₙ=λ₁, and λₘₐₓ=λₙ. However, the addition of the nonlinear cardinality constraint means that, for k<n, the optimal objective value is strictly less than λₘₐₓ(A), and the principal eigenvectors are no longer critical to the solution of the optimization problem, as in the prior art. Instead, it is the spectrum of the eigenvalues of the covariance matrix A 103 that is used to obtain the optimal solution \hat{x} 104.

Optimality Conditions

In formulating a computational strategy for the optimization of Equation (1), we first consider the conditions that must be true, assuming the optimal solution is known. A unit-norm vector \hat{x} with a cardinality k yields a maximum objective value v*. That is, the final solution vector \hat{x} is a variance maximized k-sparse eigenvector that is locally optimal for the sparsity parameter k.

For z ∈ [symbol] ^{k}, this implies that \hat{x}′A\hat{x}=z′Aₖz contains the same k non-zero principal components as the vector \hat{x}. The submatrix Aₖ 201 is the k×k principal submatrix of the covariance matrix A 103. The submatrix Aₖ is obtained by deleting the rows and columns corresponding to zero indices of the vector \hat{x}, or equivalently, by adding the rows and columns of non-zero indices, using the forward and backward search. Similar to the vector \hat{x}, the k-vector z is unit-norm, and z′Aₖz is equivalent to a standard unconstrained Rayleigh-Ritz quotient. The maximum variance of the subproblem is λₘₐₓ(Aₖ), which is the optimal objective value v*. This can be summarized by the following proposition.

Proposition 1

The optimal value v* of the sparse PCA optimization problem expressed by Equation (1) is equal to λₘₐₓ(A*ₖ), where A*ₖ is the k×k principal submatrix, of the covariance matrix A, with the largest maximal eigenvalue. In particular, the non-zero principal components of the optimal sparse vector \hat{x} are exactly equal to the principal components of u*ₖ, which constitute the principal eigenvector of the submatrix A*ₖ.

This proposition clearly indicates the combinatorial nature of the sparse PCA and the equivalent class of cardinality-constrained optimization problems. However, this exact definition of the sparse eigenvector and the necessary and sufficient conditions for optimality, especially in such simple matrix terms, does not provide an efficient method for actually determining the principal submatrix A*ₖ due to the exponential growth of the combinations C(n, k). However, an exhaustive search is practical when n is relatively small, e.g., less than about thirty, and optimality is guaranteed. Hence, the optimization problem can be solved for many practical datasets measured in the practical science and financial fields by brute force.

Variational Renormalization

Additionally, Proposition 1 provides a rather simple and highly effective computational “fix” for improving sparse principal components obtained by conventional continuous PCA methods, e.g., the methods of d'Aspremont et al., Jolliffe et al., and Zou et al, as expressed by Proposition 2.

Proposition 2

A unit-norm vector \tilde{x} with cardinality k includes candidate principal components determined by any known approximation technique. A non-zero subvector of \tilde{x} is \tilde{z}. The maximum principal eigenvector of the submatrix Aₖ is uₖ, and uₖ is defined by the same non-zero indices of the vector \tilde{x}.

If \tilde{z}≠uₖ(Aₖ), then \tilde{x} is a suboptimal solution. By replacing the non-zero principal components of \tilde{x} with those of principal eigenvector uₖ, we guarantee an increase in the variance from \tilde{v} to λₖ(Aₖ). This variational renormalization 200 indicates that any conventional PCA method can be used to determine approximate sparse principal components, i.e., the candidate solution 101, and then solve a smaller and easier unconstrained problem, i.e., the eigendecomposition of the submatrix Aₖ. This procedure, or “fix,” never decreases the quality or variance of approximate principal components. In fact, most of the time, the quality of the solution is improved.

In particular, with the prior art method of “simple thresholding”, the traditional (non-sparse) principal eigenvector is simply thresholded by setting (n−k) of the smallest absolute value loadings of uₙ(A) to zero, and then applying a an appropriate renormalizing for a unit-norm vector. Unfortunately, such a simple vector renormalization (or equivalent continuous approximations) can hardly be relied upon to yield an optimal solution, even in the subspace (subset) indicated by their non-zero elements. Thus, most conventional sparse PCA methods can be readily improved by the proper renormalization as described herein.

Variational Eigenvalue Bounds

Recall that the objective value v* obtainable from Equation (1) is bounded by the spectral radius λₘₐₓ(A) by the Rayleigh-Ritz theorem. Furthermore, the spectrum of the principal submatrices of the covariance matrix A, in part, defines the optimal solution. Not surprisingly, the two eigenvalue spectra are related by an inequality known as the Poincaré inclusion principle.

Theorem 1: The Inclusion Principle

Let A be a symmetric n×n matrix with a spectrum λ(A). Let Aₖ be any k×k principal submatrix of the matrix A for 1≦k≦n, with eigenvalues λᵢ(Aₖ). For each integer i, such that 1≦i≦k,
λᵢ(A)≦λᵢ(Aₖ)≦λᵢ₊ₙ₋ₖ(A). (2)

This theorem can be proven by imposing a sparsity pattern of cardinality k as an additional orthogonality constraint in the variational inequality of the Courant-Fischer ‘Min-Max’ theorem, for examples see, J. H. Wilkinson, “The Algebraic Eigenvalue Problem,” Clarendon Press, Oxford, England, 1965.

Therefore, the eigenvalues of a symmetric matrix form upper and lower bounds 611 for the eigenvalues 612 of all its submatrices. A special case of Equation (2), with k=n−1 leads to the well-known eigenvalue “interlacing property” of symmetric matrices:
λ₁(Aₙ)≦λ₁(Aₙ₋₁)≦λ₂(Aₙ)≦ . . . ≦λₙ₋₁(Aₙ)≦λₙ₋₁(Aₙ₋₁)≦λₙ(Aₙ), (3)
i.e., the spectra of Aₙ and Aₙ₋₁ interleave each other, with the eigenvalues of the larger matrix including those of the smaller matrix.

For positive-definite symmetric covariance matrices, augmenting a matrix Aₘ to Aₘ₊₁, by adding a new variable always expands the spectral range by reducing λₘᵢₙ and increasing λₘₐₓ. Thus, for eigenvalue maximization, the inequality constraint card(x)≦k of Equation (1) becomes an equality at the optimum.

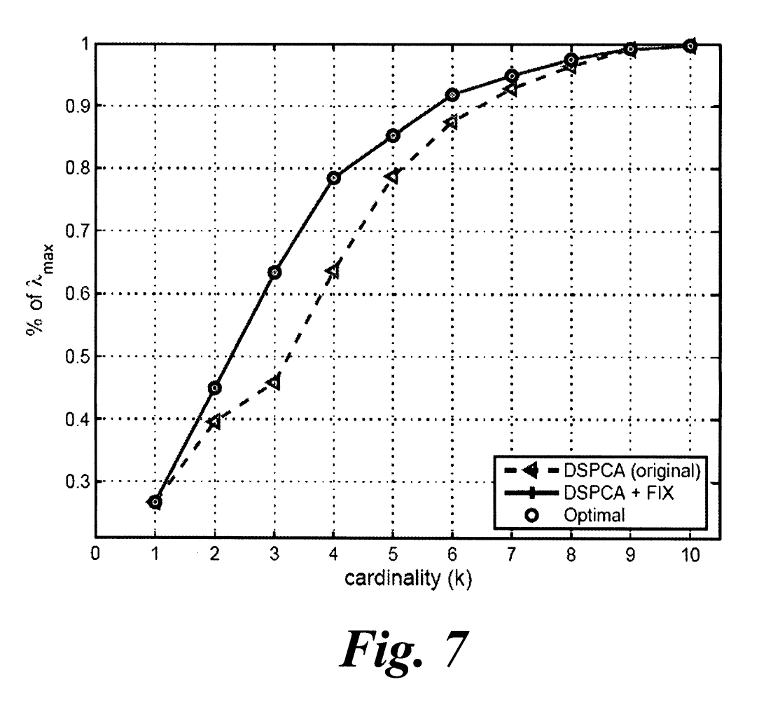

Therefore, the maximum variance is achieved at the specified upper limit k for cardinality. Moreover, the function v*(k) denotes the optimal variance for a given cardinality. The function increases monotonically with a range
[σ²ₘₐₓ(A), λₘₐₓ(A)],
   where σ²ₘₐₓ is a largest diagonal variance in the matrix A. Indeed, a concise and informative way to visualize and compare performances of sparse PCA methods is to plot their respective variance curves \tilde{v}(k), and compare the curves to the optimal variance v*(k), e.g., see FIG. 7.

Because we maximize the variance, the relevant inclusion bounds 611 are obtained by setting i=k in Equation (2). This yields lower and upper bounds for
λₖ(Aₖ)≦λₘₐₓ(Aₖ)≦λₘₐₓ(A). (4)

Surprisingly, the k^{th} smallest eigenvalue of the matrix A is a lower bound for the variance obtained with cardinality k. Thus, the lower bound enables the selection of the optimal value of k. Thus, the spectrum of matrix A, which guided the selection of eigenvectors for dimensionality reduction in conventional PCA methods, can also be used to select the cardinality k for the sparse PCA method to ensure that a desired minimum variance is obtained. Additionally, the lower bound λₖ(A) can be used for speeding up a branch-and-bound process, and for comparing the quality of various solutions with conventional performance measures, such as:
(\tilde{v}−λₖ(A))/λₘₐₓ(A).

Equation (4) defines an upper bound at λₘₐₓ(A), regardless of cardinality, which can be determined, e.g., with a power method, in all branch-and-bound sub-problems. Equation (4) can also be used pre-normalize covariances so λₘₐₓ(A)=1 or, alternatively, normalize our variance curves \tilde{v}/λₘₐₓ(A). In fact, the interleaving property leads to an interesting relation involving this bound. Among the n possible (n−1)-by-(n−1) principal submatrices of Aₙ, obtained by deleting a single j^{th} row and column, A_{\j}, there is at least one submatrix whose maximal eigenvalue is no less than n−1/n of λₙ(A):
∃ j: λₙ₋₁(A_{\j})≧(n−1/n)λₙ(A) (5)

The implication of this inequality for a branch-and-bound search process is that it is not possible for the spectral radius (λₘₐₓ) of every principal submatrix of the covariance matrix A to be arbitrarily small, especially for large n. Therefore, at moderately high cardinalities, nearly all of λₙ(A) is captured. This fact is confirmed by in increase of the lower bound λₖ(A) with increasing k.

Combinatorial Search Algorithms

Based on Propositions 1 and 2, the inclusion principle and the interleaving property, and especially given the monotonic nature of the variance curves v(k), a general class of integer programming (IP) optimization techniques can be used for determining sparse principal components as described herein.

Indeed, a greedy search process, such as backward elimination 500, is indicated by the bound in Equation (5). We can start with a full index set I={1, 2, . . . , n}, and sequentially delete the variable j which yields the maximum λₘₐₓ(A_{\j}), until only k principal components remain. For small cardinalities k<<n, the computational cost of the backward search can increase to a maximum complexity O(n⁴).

Hence, forward selection 400 can also be performed. We start with the null index set I={ }, and sequentially add the variable j, which yields the maximum λₘₐₓ(A₊ⱼ), until k principal components are selected. Forward greedy search has a worst-case complexity less than O(n³). The forward and backward searches can be combined into the bi-directional greedy search 300. We perform a greedy forward pass, from 1 to n, followed by an independent backward search from n to 1, and select a best solution for each k. This bi-directional greedy search is very effective.

Despite the expediency of near-optimal greedy search, it is nevertheless worthwhile to invest in optimal solution strategies, especially if the sparse PCA problem is in the application domain of finance or engineering, where even a small optimality gap can accrue substantial losses over time.

Our branch-and-bound search 610 exploits computationally efficient bounds, specifically, the upper bound in Equation (4). This bound is used on all active subproblems in a FIFO queue for a depth-first search. The lower bound in Equation (4) can be used to sort the queue for a more efficient best-first search. This exact sparse PCA search process will therefore find the optimal solution when it terminates. Naturally, with branch-and-bound, the search time depends on a quality of variance of the initial candidate principal component. The solutions obtained by our bi-directional greedy search can be used to initialize the exact search, because their qualities are typically quite high.

The overall best search strategy for the sparse PCA is to first perform a bi-directional greedy search 300, and use the results to initialize a branch-and-bound search 610 for an exact and optimal solution 601.

### EFFECT OF THE INVENTION

Embodiments of the invention provide a discrete spectral formulation of sparse principal component analysis using variational eigenvalue bounds. In addition, the method can renormalize any sparse eigenvector obtained by any other approximation technique (such as continuous or convex relaxations of cardinality and/or rank constraints in the optimization in Equation (1)) and thereby improve their quality by increasing their captured variance. Furthermore, efficient search algorithms are provided for obtaining sparse principal components using both greedy and exact branch-and-bound search procedures.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computer implemented method for maximizing candidate solutions to a cardinality-constrained combinatorial optimization problem of sparse principal component analysis, comprising the steps of:
inputting a candidate solution vector x of elements, a covariance matrix A measuring covariance between each possible pair of elements of the candidate solution vector x, and a sparsity parameter k denoting a cardinality of final solution; and
performing a variational renormalization of the candidate solution vector x with regards to the covariance matrix A and the sparsity parameter k to obtain a variance maximized k-sparse eigenvector x that is locally optimal for the sparsity parameter k and that is the final solution to the sparse principal component analysis optimization problem.

2. The method of claim 1, in which the variational renormalization further comprises:
replacing the largest k elements of the candidate solution vector x with k elements of a principal eigenvector u(Aₖ) of a corresponding k×k principal submatrix Aₖ of the covariance matrix A; and
setting all other elements of the candidate solution vector x to zero to obtain the variance maximized k-sparse eigenvector \hat{x}.

3. The method of claim 2, further comprising:
extracting the k×k principal submatrix Aₖ from rows and columns of the covariance matrix A.

4. The method of claim 1, further comprising:
performing a greedy search to determine a candidate solution.

5. The method of claim 4, in which the greedy search includes a bi-directional nested search including a forward pass and an independent backward pass, and further comprising:
selecting separately for the sparsity parameter k a best sparse eigenvector from either the forward pass or the backward search as the variance maximized k-sparse eigenvector.

6. The method of claim 2, in which the k non-zero values of the variance maximized k-sparse eigenvector \hat{x} are exactly equal to the k entries of a principal eigenvector u*ₖ, which correspond to a maximum eigenvalue of the k×k principal submatrix Aₖ.

7. The method of claim 1, in which the elements are a relatively small number of stocks selected from a substantially larger pool of available stocks, and the covariances measure risk/return performances between each possible pair of the stocks.

8. The method of claim 1, in which the sparsity parameter k is at least equal to a rank of an eigenvalue of the covariance matrix A nearest in magnitude to a minimal required variance for the variance maximized k-sparse eigenvector \hat{x}.

9. A computer implemented method for solving cardinality-constrained combinatorial optimization problem of sparse principal component analysis, comprising the steps of:
inputting a covariance matrix A measuring covariances between input elements for a sparse principal component analysis optimization problem, and a sparsity parameter k;
applying a greedy search to obtain a candidate solution vector x of elements; and
applying a branch-and-bound combinatorial search using the candidate solution vector x to obtain a globally optimal exact solution vector x for the cardinality-constrained combinatorial optimization problem defined by the covariance matrix A and sparsity parameter k.

10. The method of claim 9, in which the branch-and-bound combinatorial search uses eigenvalue bounds for pruning sub-problem branching paths in a search tree.

11. The method of claim 9, in which the sparsity parameter k is at least equal to a rank of an eigenvalue of the covariance matrix A nearest in magnitude to a minimal required variance for the variance maximized k-sparse eigenvector \hat{x}.

12. The method of claim 9 in which the elements are a relatively small number of stocks selected from a substantially larger pool of available stocks, and the covariances measure risk/return performances between each possible pair of the stocks.
